(19) United States
(12) Patent Application Publication
(10) Pub. No.: US 2007/0044842 A1
(43) Pub. Date: Mar. 1, 2007

(54) Valve assembly with manual override cover

(75) Inventors: Marcus J.M. Boertje, Port Washington, NY (US); Michael Zona, Melville, NY (US); Michael E. Foy, Baldwin, NY (US)

Correspondence Address: HOFFMANN & BARON, LLP, 6900 JERICHO TURNPIKE, SYOSSET, NY, 11791, US

(73) Assignee: Festo Corporation

(21) Appl. No.: 11/215,263

(22) Filed: Aug. 30, 2005

(51) Int. Cl. F16K 27/08

(52) U.S. Cl. 137/382

(57) ABSTRACT

A valve assembly generally including a valve base having a plurality of internal conduits formed therein, at least one valve mounted to the base and in fluid communication with at least one internal conduit of the base and an override cover removably attached to the valve base. The valve has a manually activatable override element for actuating the valve and the cover has a label holder portion defining a pocket adapted to retain a label therein and a planar cover plate portion extending from the label holder portion over the override element of the valve. Thus, the cover plate portion forms a barrier for preventing accidental activation of the override element.

### FIELD OF THE INVENTION

The present invention relates generally to stacked valve systems used for supplying independent fluid streams under pressure, and more particularly to a high density valve assembly having an improved manual override cover.

### BACKGROUND OF THE INVENTION

In order to control machinery in the industrial or laboratory environment, it is well known to use electronically controlled fluid power valves and actuators. Stacked valve systems, for example, are used in various manufacturing and other applications where pressurized independent fluid streams are required. Generally, such systems typically include multiple pneumatic valves installed in “banks” and commonly directly connected to a manifold or indirectly connected to a manifold via a single sub-base. The manifold and/or single subbase generally have internal conduits formed therein to provide fluid communication between each pneumatic valve and an associated outlet. Thus, each pneumatic valve is typically mechanically fastened or otherwise secured to the manifold adjacent its associated outlet. An electronic valve control system is usually provided to independently actuate the valves.

Each individual valve of such valve systems usually includes some type of a manually operated override for individually actuating the valve apart from the valve control system. The override may consist of a button or a switch which is manually manipulated to actuate the valve for trouble-shooting or repair purposes, for example. To prevent inadvertent or accidental actuation of the overrides, the valve manifold assembly may include an override cover assembly disposed over or above the overrides. Some cover assemblies are hinged so that a door can be pivoted out of the way to access the overrides. Additionally, some cover assemblies include means for displaying written information regarding operation of the valve assembly. Such information may be provided on a label that is affixed on the cover and contains information regarding individual valve functions or identifications.

One drawback of prior art override cover assemblies is the ease with which the cover can be accidentally removed or displaced. This obviously defeats the purpose of the cover, which is to protect the overrides from accidental actuation. Another drawback of prior art cover assemblies is their multiple parts and their complexity in design, both of which tend to increase manufacturing costs and time. Still another drawback of prior art cover assemblies is the limited space provided for displaying written information and the inability to remove or replace the information if desired.

Accordingly, it would be desirable to provide a simply designed override cover assembly that is not easily removed from the valve assembly to prevent accidental actuation of the overrides. It is further desirable to provide a cover assembly with means to display a larger amount of written information and to remove and replace the information if desired.

### SUMMARY OF THE INVENTION

The present invention is a valve assembly generally including a valve base having a plurality of internal conduits formed therein, at least one valve mounted to the valve base and in fluid communication with at least one internal conduit of the valve base and an override cover removably attached to the valve base. The valve has a manually activatable override element for actuating the valve and the cover has a label holder portion defining a pocket adapted to retain a label therein and a planar cover plate portion extending from the label holder portion over the override element of the valve. Thus, the cover plate portion forms a barrier for preventing accidental activation of the override element.

In a preferred embodiment, the label holder portion of the override cover is removably attached to the valve base. In this regard, the label holder portion includes at least one rail extending from a bottom surface thereof and the valve base includes at least one groove formed therein for engaging the rail of the label holder portion for removably attaching the override cover to the valve base.

Also, the label holder portion is preferably in the form of a sheet member folded over itself to form an upper layer, a lower layer and the label retaining pocket therebetween. The upper and lower layers preferably impart a clamping force therebetween to secure the label within the pocket. Additionally, the override cover is preferably formed of a transparent or translucent material, whereby the label is visible through the label holder portion.

The cover plate portion of the override cover is further preferably made detachable from the label holder portion. For example, the cover may further include a frangible portion disposed between the cover plate portion and the label holder portion to facilitate breakable detachment of the cover plate portion from the label holder portion. This frangible portion may be in the form of a crease formed between the cover plate portion and the label holder portion.

A preferred form of the valve manifold with improved override cover, as well as other embodiments, objects, features and advantages of this invention, will be apparent from the following detailed description of illustrative embodiments thereof, which is to be read in conjunction with the accompanying drawings.

### BRIEF DESCRIPTION OF THE DRAWINGS

FIG. 1 is a perspective view of a valve assembly formed in accordance with the present invention.

FIG. 2 is a perspective view of the override cover shown in FIG. 1.

FIG. 3 is a partial cross-sectional view of the valve assembly shown in FIG. 1 taken along the line 3-3.

FIG. 4 is an enlarged cross-sectional view of the cover fitted on the valve base shown in FIG. 3.

### DETAILED DESCRIPTION OF ILLUSTRATIVE EMBODIMENTS

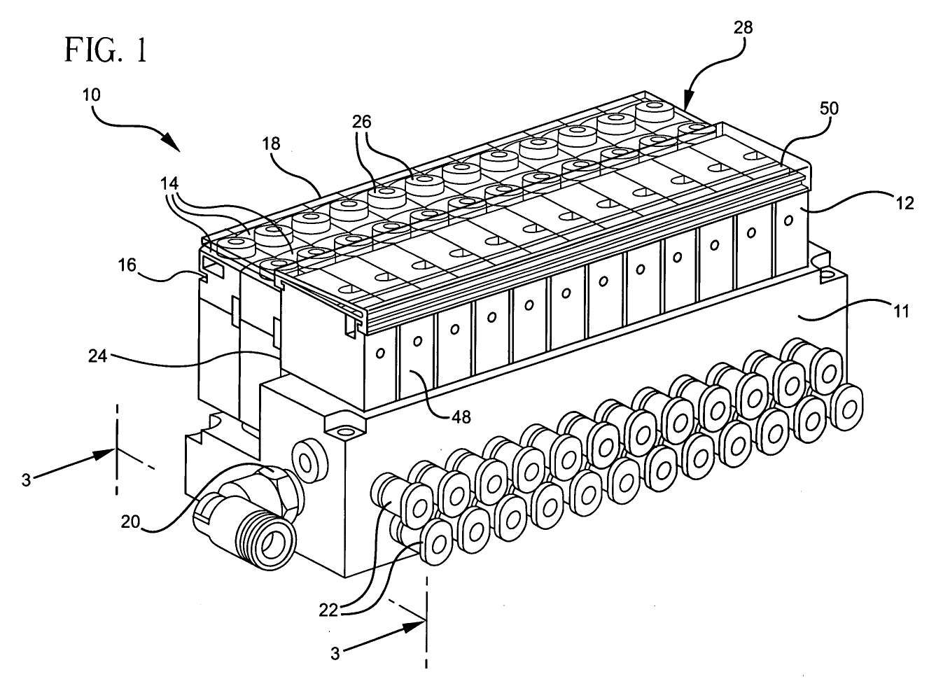

Referring now to FIGS. 1-4, a valve assembly 10 formed in accordance with the present invention is shown. In general, the valve assembly 10 includes a manifold 11 and a valve base 12 designed to support a plurality of stacked pneumatic valves 14, which may be arranged one on top of the other. The valves 14 may be secured to the base 12 and to each other in a conventional manner, such as by threaded fasteners 16, and include electrical contacts 18 for electrical connection to a control system (not shown) for activating the valves. The assembly 10 described herein is a pneumatic system utilizing pneumatic valves, however, it is conceivable that the valve assembly according to the present invention can be designed to be fluid operated.

The manifold 11 and the valve base 12 of the present invention are made from a durable material, such as aluminum, and include a plurality of internal conduits formed therein. The manifold 11 and the base 12 can be integrated into a single unit, or they may be provided as separate units, as shown in FIG. 1. As used herein, the term “valve base” defines both integrated base/manifold arrangements, wherein the manifold is deemed to have a base portion for mounting the valves, and separate base/manifold arrangements, wherein the valves are mounted to the base and the base, in turn, is mounted to the manifold. Also, the term “valve base” as used herein defines both a single unit having a plurality of valves mounted thereto or individual units stacked together, wherein each unit has a single valve mounted thereto.

Preferably, extending along the length of the manifold 11 is a common fluid supply line 20 having transverse branches, which fluidly connect the supply line to the individual valves 14 via the internal conduits of the valve base 12. To keep manifold dimensions to a minimum, the air supply for each valve stack is preferably shared. However, individual working fluid supply lines may also be provided for each valve. The manifold 11 further includes outlet ports 22, wherein each port is in fluid connection with a respective valve 14 via the internal conduits of the valve base 12. As shown in FIG. 1, the transverse fluid supply line 20 and the outlet ports 22 are formed generally perpendicular to each other.

As mentioned above, secured to one of the surfaces 24 of the valve base 12 is at least one row, and preferably a stack of two rows, of valves 14. The first row of valves 14 is secured directly to the surface 24 of the valve base 12 and a second row of valves is secured on the first row. This arrangement can be repeated, if desired, by attaching a third row of valves on top of the second row and so on. All flow fluid interfaces between the valves and between the first valve row and the valve base 12 are preferably separated by a fluid-tight seal commonly used in the art to prevent fluid leakage.

Each valve 14 is provided with a manual override 26 which permits actuation of the valve independently of the control system. This function is desired during initial installation of the valve assembly 10 and for subsequent trouble-shooting and repairs. The override 26 may simply be a depressible button or switch, which causes an actuator within the valve 14 to activate the valve when pressed. Other forms of manual overrides may also be utilized in accordance with the present invention.

To prevent accidental or inadvertent actuation of the valve overrides 26, the valve manifold assembly 10 further includes an override cover 28 positioned over or above the overrides. The cover 28 is preferably made from a durable, clear or translucent plastic, such as polyvinylchloride (PVC). The plastic material of the cover 28 may also be tinted in various colors to identify the valve assembly function. The cover 28 is preferably extruded, but other forming techniques may be utilized, such as injection molding.

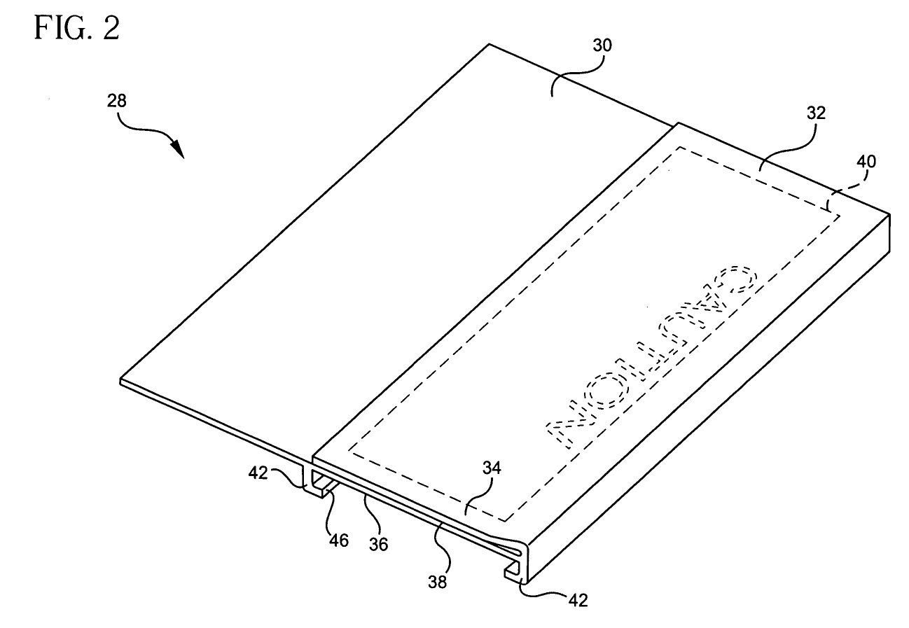

As shown most clearly in FIG. 2, the cover 28 preferably includes a cover plate portion 30 and a label holder portion 32. The cover plate portion 30 is integrally formed with the label holder portion 32 and generally consists of a flat planar sheet extending from the label holder portion and being generally coplanar therewith. The label holder portion 32 generally consists of a flat sheet folded over itself to form an upper layer 34 and a lower layer 36 and a narrow pocket 38 therebetween. The upper and lower layers 34 and 36 are preferably formed during extrusion in a manner in which a clamping force will be imparted therebetween. This can be achieved by providing a slight overbend to the upper layer 34 so that the layers are not parallel. The lower layer 34 of the label holder portion is preferably contiguous and coplanar with the cover plate portion 30.

The pocket 38 formed between the upper and lower layers 34 and 36 of the label holder portion 32 is designed to removably secure therein a label 40 containing written information concerning the function or operation of the valve assembly 10. This information may pertain to the function of each individual valve 14 or may contain general cautionary or safety information. Because the cover 28 is preferably made from a clear or translucent plastic material, the label 40 is readily visible through the upper layer 34 of the label holder portion 32, while at the same time is protected from any dirt or debris, which may fall thereon. Moreover, the label 40 is held in place by the clamping action between the upper and lower layers 34 and 36 of the label holder portion 32, but can be easily slipped out of the pocket 38 and replaced with a new label when desired.

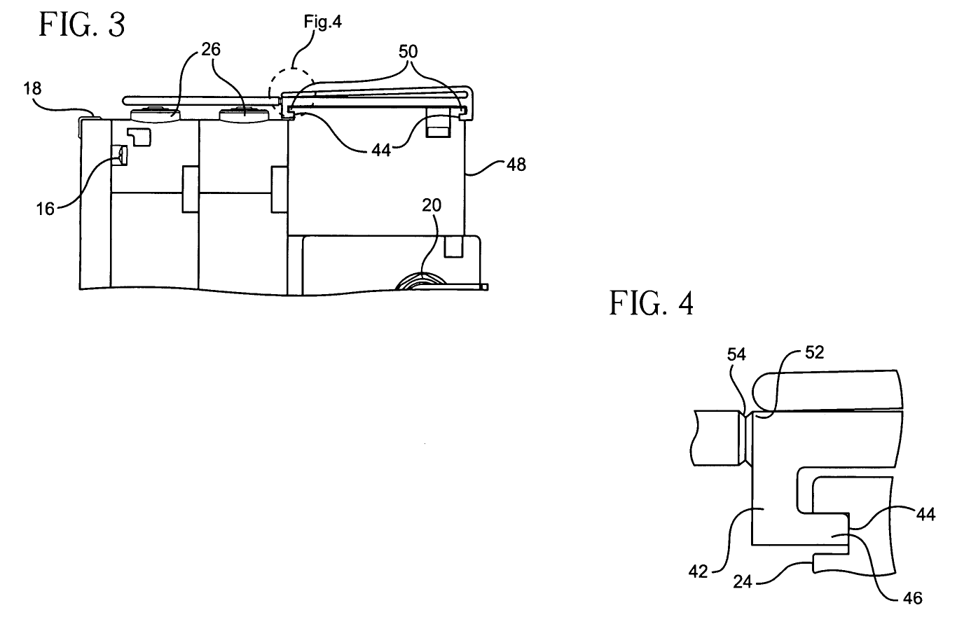

The cover 28 is preferably secured to the valve base 12 by a tight sliding fit arrangement. In particular, the cover 28 preferably includes a pair of rails 42 formed on a bottom surface of the label holder portion 32, which engage grooves 44 formed on the valve base 12 to secure the cover to the base. The rails 42 preferably extend the length of the cover 28 and include inwardly directed fingers 46 which are received in correspondingly sized grooves 44 formed on opposite surfaces of the valve base 12, as shown in FIG. 3. More specifically, the valve mounting surface 24 of the valve base 12 includes a groove 44 for receiving a finger 46 of one of the rails 42, while a surface 48 of the base 12 opposite the valve mounting surface 24 includes the other groove for receiving the other rail finger of the cover. In this regard, the space between the rails 42 is generally equal to the distance between the valve mounting surface 24 and the opposite surface 48. Thus, the cover 28 can be slid in position from one of the longitudinal ends of the valve base 12. It is also conceivable that the cover can be connected to the base 12 by snapping the rails into the grooves from above.

The cover 28 is thus secured to the valve base 12 so that the label holder portion is positioned over an upper surface 50 of the base and the cover plate portion 30 extends out over the manual overrides 26 of the valves 14. The cover plate portion 30 thus provides a physical barrier against accidental actuation of the overrides 26. When it is necessary to manually activate one or more overrides 26, the cover 28 can be easily removed from the valve base 12 by sliding it off the manifold in a longitudinal direction, or by otherwise disengaging the rails 42 of the cover from the grooves 44 of the manifold.

In a preferred embodiment, the cover plate portion 30 of the cover 28 is made detachable from the label holder portion 32. This feature may be desirable to further facilitate access to the overrides 26, or in situations where the overrides do not require covering. To make the cover plate portion 30 removable from the label holder portion 32, the cover 28 is formed with a frangible portion 52 therebetween. As shown most clearly in FIG. 4, the frangible portion 52 preferably includes a depression or crease 54 formed on opposite sides of the cover plate portion 30 to thereby provide a weakened, breakable junction between the cover plate portion and the label holder portion. When desired, the cover plate portion 30 can simply be lifted about the frangible portion 52 until it breaks free of the label holder portion 32. Meanwhile, the label holder portion 32 may be retained on the valve base 12, thereby providing access to the manual overrides 26 of the valves without removing the entire cover 28. It is conceivable that the frangible portion 52 may include other means, such as perforations or intermittent slits, for forming a breakable junction. In other words, the invention is not limited to the creases 54 shown in FIG. 4.

As a result of the present invention, the above-identified needs in the art are met by providing a simply designed cover to protect the overrides from accidental actuation and further providing an increased amount of space for displaying removable written information.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A valve assembly comprising:
a valve base having a plurality of internal conduits formed therein;
at least one valve mounted to said valve base and in fluid communication with at least one internal conduit of said base, said valve having a manually activatable override element for actuating said valve; and
an override cover removably attached to said valve base, said cover including a label holder portion defining a pocket adapted to retain a label therein and a planar cover plate portion extending from said label holder portion over said override element of said valve, said cover plate portion forming a barrier for preventing accidental activation of said override element.

2. A valve assembly as defined in claim 1, wherein said label holder portion of said override cover is removably attached to said valve base.

3. A valve assembly as defined in claim 2, wherein said label holder portion includes at least one rail extending from a bottom surface thereof and said valve base includes at least one groove formed therein, said rail engaging said groove for removably attaching said override cover to said valve base.

4. A valve assembly as defined in claim 1, wherein said label holder portion comprises a sheet member folded over itself to form an upper layer, a lower layer and said label retaining pocket therebetween.

5. A valve assembly as defined in claim 4, wherein said upper and lower layers impart a clamping force therebetween.

6. A valve assembly as defined in claim 1, wherein said override cover is formed of a transparent or translucent material, whereby said label is visible through said label holder portion.

7. A valve assembly as defined in claim 1, wherein said cover plate portion of said override cover is detachable from said label holder portion.

8. A valve assembly as defined in claim 7, wherein said override cover further includes a frangible portion disposed between said cover plate portion and said label holder portion to facilitate breakable detachment of said cover plate portion from said label holder portion.

9. A valve assembly as defined in claim 8, wherein said frangible portion comprises a crease formed between said cover plate portion and said label holder portion.

10. A valve manual override cover comprising an integrally formed unitary element including a label holder portion and a planar cover plate portion extending from said label holder portion, said label holder portion defining a pocket adapted to retain a label therein and said cover plate portion being adapted to form a physical barrier over a valve manual override.

11. A valve manual override cover as defined in claim 10, wherein said label holder portion includes at least one rail extending from a bottom surface thereof for engagement with a groove formed on a valve base having the valve mounted thereon.

12. A valve manual override cover as defined in claim 10, wherein said label holder portion comprises a sheet member folded over itself to form an upper layer, a lower layer and said label retaining pocket therebetween.

13. A valve manual override cover as defined in claim 12, wherein said upper and lower layers impart a clamping force therebetween.

14. A valve manual override cover as defined in claim 10, wherein said override cover is formed of a transparent or translucent material, whereby said label is visible through said label holder portion.

15. A valve manual override cover as defined in claim 10, wherein said cover plate portion of said override cover is detachable from said label holder portion.

16. A valve manual override cover as defined in claim 15, wherein said override cover further includes a frangible portion disposed between said cover plate portion and said label holder portion to facilitate breakable detachment of said cover plate portion from said label holder portion.

17. A valve manual override cover as defined in claim 16, wherein said frangible portion comprises a crease formed between said cover plate portion and said label holder portion.
